(19) United States
(12) Patent Application Publication
(10) Pub. No.: US 2026/0339620 A1
(43) Pub. Date: Oct. 29, 2026

(54) SYSTEMS AND METHODS FOR TYPE ENFORCEMENT AND SYNCHRONIZATION ACROSS REST INTERFACES

(71) Applicant: Delos Ford, Folsom, CA (US)

(72) Inventor: Delos Ford, Folsom, CA (US)

(21) Appl. No.: 19/192,961

(22) Filed: Apr. 29, 2025

(51) Int. Cl. G06F 8/30; G06F 8/38; G06F 8/71

(52) U.S. Cl. CPC G06F 8/315; G06F 8/38; G06F 8/71

(57) ABSTRACT

A system, method, and computer-readable medium for enforcing strong typing across a REST interface by automating TypeScript type generation, JSON synchronization, and cyclical reference resolution. The system includes a Java Object Annotation Module that extracts type metadata, a TypeScript Generation Module that automatically produces TypeScript type definitions, a JSON Serialization Module that preserves object relationships while handling cyclical references, and a Frontend Runtime Component that dynamically constructs strongly typed TypeScript objects from JSON data. The embodiments eliminate manual type synchronization, automates JSON serialization with reference tracking, and enforces runtime type safety, improving reliability and reducing development effort in REST API-based applications.

### TECHNICAL FIELD

The embodiments disclosed herein generally relate to systems and methods for type enforcement and synchronization of data structures across RESTful (REST) application programming interface (API) interfaces.

### BACKGROUND

Modern software development involves frequent interaction between backend and frontend components, particularly in web applications where data is exchanged over REST interfaces. Ensuring strong typing across a REST interface is a persistent challenge, especially when the backend is implemented in Java and the frontend relies on TypeScript.

Currently, developers must manually synchronize type definitions between backend Java objects and frontend TypeScript types. When changes occur in the backend, corresponding JSON structures and TypeScript interfaces must be manually updated to maintain type integrity. This process is error-prone, time-consuming, and often results in mismatches that lead to runtime errors and debugging challenges.

While some existing tools assist with type inference and conversion, they lack automatic synchronization capabilities. Moreover, conventional JSON serialization frameworks do not adequately support cyclical references within object relationships, causing inconsistencies in data transfer.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein disclosed a system and method for enforcing strong typing across REST interfaces, enabling automated TypeScript code generation and JSON synchronization from Java objects. The system utilizes Java annotations to define object mappings, generates TypeScript interfaces dynamically, and synchronizes JSON representations to ensure type consistency. The solution simplifies code maintenance, eliminates manual synchronization errors, and improves development efficiency.

In some aspects, the system provides cross-language type safety to ensure automatic synchronization of type definitions between Java and TypeScript.

In some aspects, the system provides automated TypeScript code generation from Java objects and bidirectional object reference handling to resolve cyclical references in JSON serialization, ensuring type-safe object relationships.

In some aspects, the system functions at the API and development level for REST interfaces.

On some aspects, the system provides a novel software library, which automatically enforces strong typing between Java backends and TypeScript frontends. The system operates by: Generating TypeScript Code: The library automatically converts Java objects into TypeScript interfaces, ensuring structural consistency. Handling Cyclical References: Unlike existing tools, the system resolves cyclic dependencies within object relationships. Synchronizing JSON Serialization: The system ensures that JSON representations of Java objects remain consistent with TypeScript types. Utilizing Java Annotations: Developers annotate Java objects to specify included fields and enforce type safety. Automating Build Processes: The tool integrates with Java build systems to update TypeScript definitions dynamically. These features significantly reduce development effort, eliminate manual synchronization errors, and enhance maintainability.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates a block diagram of the system architecture components, according to some embodiments;

FIG. 3 illustrates a flowchart of a TypeScript generation process, according to some embodiments;

FIG. 4 illustrates a flowchart of JSON serialization and cyclical reference handling, according to some embodiments;

FIG. 5 illustrates a block diagram of the build process module, according to some embodiments; and

FIG. 6 illustrates a flowchart a process for runtime type enforcement in the frontend, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a system and method for enforcing strong typing across REST interfaces, enabling automated TypeScript code generation and JSON synchronization from Java objects. The system utilizes Java annotations to define object mappings, generates TypeScript interfaces dynamically, and synchronizes JSON representations to ensure type consistency. The solution simplifies code maintenance, eliminates manual synchronization errors, and improves development efficiency.

The system relates to a Java library designed to enforce strong typing across REST interfaces when using TypeScript for front-end development. The library's primary innovation lies in its ability to automatically generate and synchronize TypeScript code and JSON data based on Java object annotations, ensuring type safety across the full stack without manual intervention.

The system provides automatic type conversion and synchronization between Java and TypeScript. The library maps Java collections to their TypeScript equals. They are then converted to TypeScript Arrays, and Java Maps are transformed into TypeScript Maps. The library provides the ability to handle references in object relationships. For example, if two User objects reference each other in a relationship, the system manages these bidirectional references during generation.

The library operates through a combination of Java annotations and reflection. Users must add the ‘AutoTypeFactoryType’ annotation to target objects, specifying either ‘FactoryType.SIMPLE’ or ‘FactoryType.ANNOTATION’ to control field inclusion behavior. The system requires an ‘opens’ declaration in the module-info file for reflection-based operations. The build process uses the ‘TSGenerator’ class, which accepts a collection of packages and an output directory for TypeScript code generation. Runtime JSON generation is handled by the ‘JSONPropertyMapperFactory’ and ‘JSONPropertyMapper’ packages, which create type-safe JSON responses for AJAX communications.

The system's novelty includes its ability to provide automatic enforcement of strong typing across REST interfaces and its maintenance of TypeScript code and JSON data structures. When developers modify Java object fields, the library automatically updates all related TypeScript types and JSON generation logic, eliminating the traditional need to update multiple code locations manually. This automatic synchronization reduces maintenance overhead and potential type-related errors. Another technical improvement is the front-end integration through the provided static class, which includes type-safe building methods that convert JSON. parse results into proper TypeScript types. This ensures type safety from the server response through to the client-side code execution.

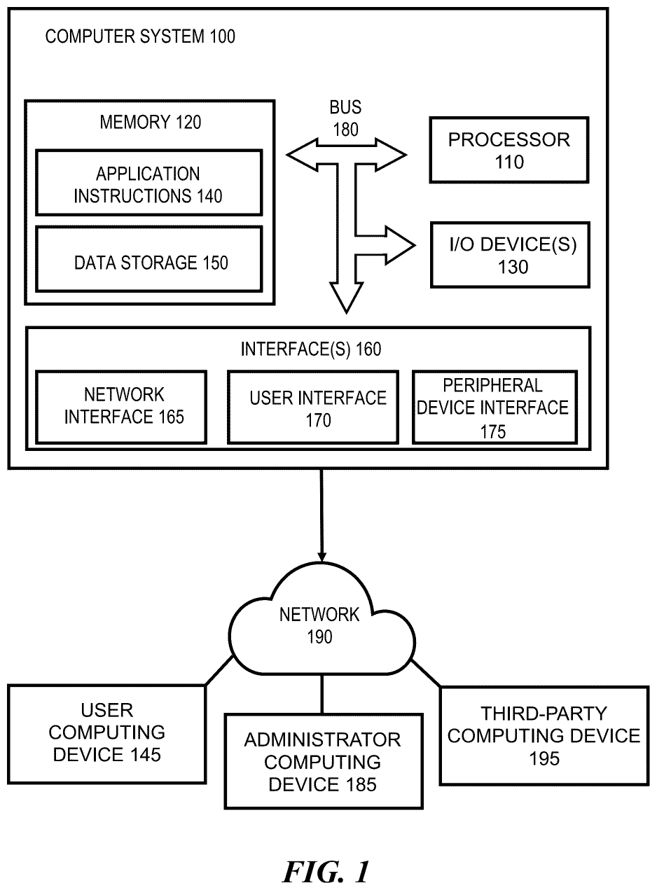

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and non-volatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145 an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

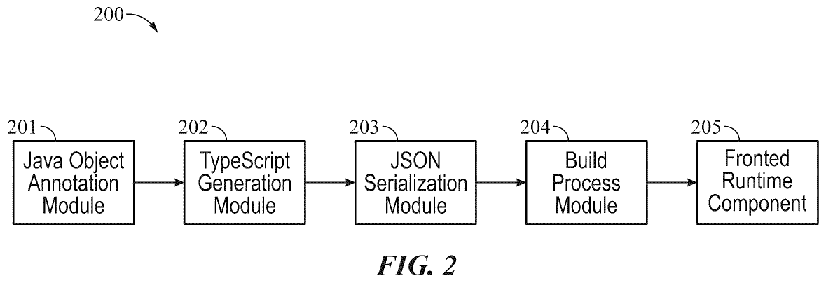

FIG. 2 illustrates a illustrates a block diagram of the system architecture for enforcing strong typing across a REST interface by automatically generating TypeScript type definitions, synchronizing JSON representations, and resolving cyclical references. The system comprises a Java Object Annotation Module 201 to receive annotated Java objects and extracts type metadata for processing. A TypeScript Generation Module 202 converts annotated Java objects into TypeScript type definitions, ensuring synchronization between backend and frontend structures. A JSON Serialization Module 203 generates JSON representations while resolving cyclical references using reference tracking. A Build Process Module 204 integrates with a Java build system (e.g., Maven, Gradle) to automatically regenerate TypeScript type definitions and JSON serialization logic, wherein the Java object structures are detected through automated static analysis during the build process. A Frontend Runtime Component 205 parses received JSON, constructs strongly typed TypeScript objects, and enforces runtime type validation before application usage.

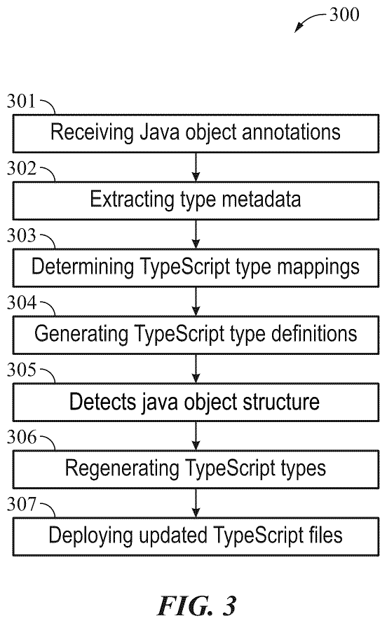

FIG. 3 illustrates a flowchart depicting the process of automatically generating TypeScript type definitions from annotated Java objects. The process includes the following steps. In step 301, the system receives Java object annotations and detects Java objects annotated with predefined metadata. In step 302, the system extracts type metadata by scanning the Java object for type definitions, collection structures, and reference identifiers. In step 303, the system determines TypeScript type mappings by mapping Java collection types (e.g., List<>, Map<>) to TypeScript equivalents (e.g., Array<>). In step 304, the system generates TypeScript type definitions. A TypeScript interface file is automatically created and stored in the frontend repository. In step 305, the system detects Java object system wherein the Java object structures are detected through automated static analysis during the build process. In step 306, the Typescript types are generated/regenerated. In step 307, the TypeScript files are deployed such that the frontend application loads the latest TypeScript types for use.

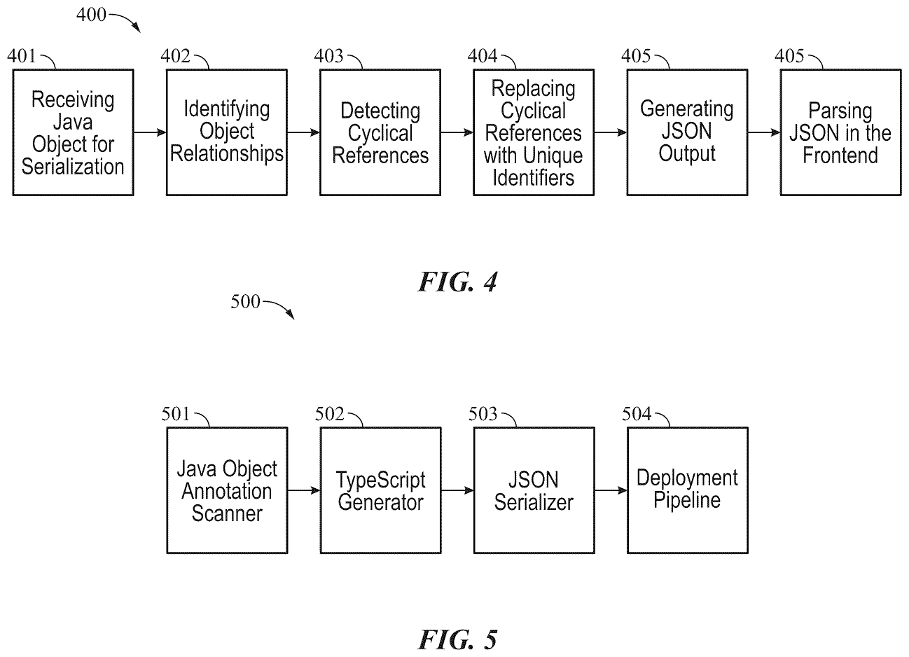

FIG. 4 depicts a flowchart of the JSON serialization process, highlighting how the system resolves cyclical references in Java object structures. In step 401 the system processes a Java object to generate its JSON representation to receive the Java object for serialization. In step 402, The system analyzes references within the object graph to identify object relationships. In step 403, to detect cyclical references, if a reference loop is detected, the system assigns a unique reference identifier to the object. In step 404, cyclical references are replaced with unique identifiers. Instead of duplicating objects, the system inserts reference placeholders (“$ref”) in the JSON output. In step 405, the final JSON representation is constructed with reference tracking to generate the JSON output. In step 406, JSON is parsed in the frontend via the Frontend Runtime Component which reconstructs objects by resolving reference identifiers into their corresponding instances.

FIG. 5 illustrates the Build Process Module (104), which ensures automatic synchronization between Java object definitions and their corresponding TypeScript types and JSON serialization logic. The key components include a Java Object Annotation Scanner 501, a TypeScript Generator 502, a JSON sterilizer 503, and a deployment pipeline 504. The Java Object Annotation Scanner 501 detects Java object structures using automated static analysis. The TypeScript Generator 502 regenerates TypeScript type definitions and Typescript code for loading the JSON response from the back-end into the Typescript types (thus enforcing strong typing across the REST interface). The JSON Serializer 503 (i.e., the JSONPropertyMapper) updates JSON serialization rules when Java object structures are modified. The Deployment Pipeline 504 ensures that newly generated TypeScript type definitions and JSON serialization rules are correctly deployed to the frontend.

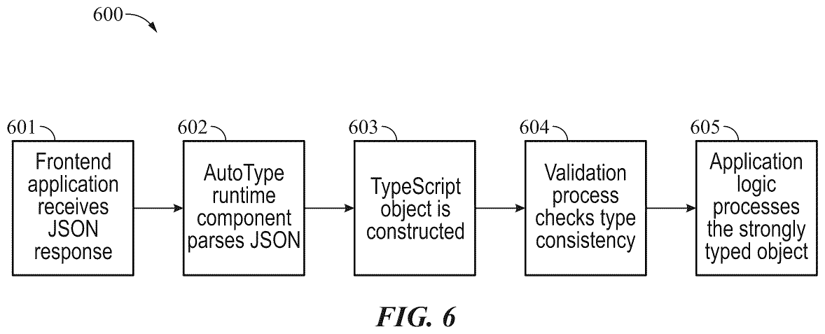

FIG. 6 illustrates a flowchart of the runtime enforcement process that ensures TypeScript objects conform to backend Java object structures. The sequence includes (block 601) a Frontend application receiving JSON response wherein a REST API call returns a JSON response. In block 602, an AutoType runtime component parses JSON to parse the JSON into an intermediate data structure. In block 603, the runtime system instantiates a TypeScript object based on the pre-generated TypeScript definitions to construct the TypeScript. In block 604, a validation process checks type consistency to enable the system to ensure that the received JSON fields match the expected TypeScript structure. In block 605, the application logic processes the strongly typed object while safely using the validated TypeScript object. This sequence ensures that frontend applications only process type-safe objects, reducing runtime errors and data inconsistencies.

Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flow-chart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for type enforcement and synchronization across REST interfaces, the system comprising:
at least one user computing device in operable connection with a user network;
an application server in operable communication with the user network, the application server configured to host an application program for performing automatic type enforcement and synchronization across one or more Rest API's, the application program in operable communication with one or more processors coupled to a memory, wherein the one or more processors are configured to perform the following:
add a field to a class;
run a TSGenerator to build a TypeScript code; and
utilize the field in the TypeScript code to automatically generate and enforce one or more synchronized type-safe interfaces across a Java backend and Typescript front end system through one or more REST API's.

2. The system of claim 1, wherein the processor is configured to utilize one or more Java annotations to automatically generate and synchronize the Typescript code and a plurality of JSON data.

3. The system of claim 1, wherein the processor enables a library to be included to a module path.

4. The system of claim 3, wherein the processor enables a “requires com.autoype” to be added to a module-info.

5. The system of claim 4, wherein the processor enables an opens declaration to be added to one or more packages associated with the library.

6. The system of claim 5, wherein the processor enables an AutoTypeFactoryType annotation to be added to the one or more objects.

7. The system of claim 6, wherein the AutoTypeFactoryType is associated with a FactoryType.SIMPLE.

8. The system of claim 7, wherein the AutoTypeFactoryType is associated with a FactoryType.ANNOTATION.

9. The system of claim 8, wherein the FactoryType.SIMPLE or the FactoryType.ANNOTATION specifies if all of one or more fields are included or if one or more annotations are used to specify the one or more fields included in the TypeScript code.

10. The system of claim 9, wherein the processor enables one or more AutoTypeField annotations or one or more AutoTypeID annotations to be added to the TypeScript code.

11. The system of claim 10, wherein the processor passes a collection of the class and a directory to output the Typescript code to the TSGenerator.

12. The system of claim 11, wherein an AJAX server is utilized with a JSONPropertyMapperFactory and a class type to create a JSONPropertyMapper to generate the JSON data for the one or more objects and to return the JSONPropertyMapper output as an AJAX response.

13. A method for type enforcement and synchronization across REST interfaces, the method comprising the steps of:
including a library to a module path;
generating and synchronizing, via one or more Java annotations, a Typescript code and a plurality of JSON data;
including a library to the module path;
adding a “requires com.autoype” to be added to the module path;
adding an opens declaration to one or more packages associated with the library;
adding an AutoTypeFactoryType annotation to one or more objects;
associating the AutoTypeFactoryType with a FactoryType.SIMPLE or a FactoryType.ANNOTATION. to specify if all of one or more fields are included or if one or more annotations are used to specify the one or more fields included in the TypeScript code;
adding one or more AutoTypeField annotations or one or more AutoTypeID annotations to the TypeScript code;
passing a collection of one or more packages and one or more directories to output the Typescript code to the TSGenerator; and
creating, via an AJAX server utilizing JSONPropertyMapperFactory with a class type, a JSONPropertyMapper to generate the JSON data for the one or more objects and to return the JSONPropertyMapper output as an AJAX response.

14. The method of claim 13, further comprising validating the generated TypeScript type definitions against the Java object structure to ensure consistency.

15. The method of claim 13, wherein cyclical references are resolved using reference identifiers, and the frontend runtime reconstructs objects by matching reference identifiers to previously instantiated objects.

16. The method of claim 13, wherein the Java object structures are detected through automated static analysis during the build process.

17. The method of claim 13, further comprising the step of versioning the generated TypeScript definitions and JSON serialization logic to ensure backward compatibility.

18. The method of claim 13, wherein the system supports custom serialization rules to modify how Java object fields are represented in JSON.

19. A computer-readable medium storing instructions that, when executed by a processor, perform a method for enforcing strong typing across a REST interface, the method comprising the steps of:
receiving one or more Java objects annotated with a type metadata and extracting structural information;
generating TypeScript type definitions based on the one or more Java objects;
generating one or more JSON representations to maintain strong typing and one or more cyclical references; and
exposing a frontend runtime interface to enable type-safe parsing of a plurality of JSON data and dynamic instantiation of TypeScript objects.

20. The method of claim 19, further comprising the step of: validating a consistency of the TypeScript objects.
